(19) United States
(12) Patent Application Publication
(10) Pub. No.: US 2011/0168042 A1
(43) Pub. Date: Jul. 14, 2011

(54) Variable Oscillating Web Printing Press and Method

(75) Inventors: Glenn Alan GUARALDI, Kingston, NH (US); Mehmet Oktay KAYA, Exeter, NH (US)

(73) Assignee: GOSS INTERNATIONAL AMERICAS, INC., Durham, NH (US)

(21) Appl. No.: 12/984,776

(22) Filed: Jan. 5, 2011

Related U.S. Application Data
(60) Provisional application No. 61/293,951, filed on Jan. 11, 2010.

(51) Int. Cl. B41F 13/54; B41F 1/34

(52) U.S. Cl. 101/228; 101/485

(57) ABSTRACT

A printing press is provided that includes a printing section including at least one printing unit printing images on a web and at least one compensator unit for varying the direction of travel of the web in the printing section during operation of the at least one printing unit. A method of printing is also provided

This claims the benefit of U.S. Patent Application No. 61/293,951, filed Jan. 11, 2010 and hereby incorporated by reference herein.

The present invention relates generally to printing presses and more specifically to a variable cutoff oscillating web printing press and method.

### BACKGROUND OF INVENTION

In one variable cutoff printing design, first plate and blanket cylinder sleeves mounted on respective mandrels are replaced with second plate and blanket cylinder sleeves that vary in thickness from the first plate and blanket cylinder sleeves. After changing the plate and blanket cylinder sleeves, ink rollers, the blanket cylinder and an impression cylinder may need to be adjusted to new positions for appropriate contact with the plate cylinder. For this design, cylinder diameter and cutoff length of the plate and blanket cylinders may have a minimum limit because the changeable sleeves are placed on rigid mandrels.

In a second design, first plate and blanket cylinders may be removed from a print unit and replaced with second plate and blanket cylinders that vary in diameter from the first plate and blanket cylinders to vary the cutoff length.

In a third design, plate, blanket and impression cylinders may be part of a cartridge. In order to vary the cutoff length, a first cartridge including first plate, blanket and impression cylinders is removed and replaced with a second cartridge including second plate, blanket and impression cylinders that vary in diameter from the first plate, blanket and impression cylinders.

### BRIEF SUMMARY OF THE INVENTION

A printing press is provided that includes a printing section including at least one printing unit printing images on a web and at least one compensator unit for varying the direction of travel of the web in the printing section during operation of the at least one printing unit.

A method of printing is also provided that includes the steps of printing a first image of a first print job on a web traveling in a first direction; transporting the web in a second direction opposite the first direction; transporting the web in the first direction; and printing a second image of the first print job on the web adjacent to the first image.

A printing press including a printing section including a plurality of printing units is also provided. Each printing unit includes a plate cylinder, a blanket cylinder and a third cylinder arranged for a web to pass between the blanket cylinder and the third cylinder. The printing press also includes a first compensator unit upstream of the printing section and a second compensator unit downstream of the printing section. The first and section compensator units vary the direction of travel of the web in the printing section during operation of the plurality of printing units.

### BRIEF DESCRIPTION OF THE DRAWINGS

The present invention is described below by reference to the following drawings, in which:

FIGS. 1 and 2 schematically show a oscillating web printing press according to an embodiment of the present invention;

FIG. 3 schematically shows a web entering a printing section of the printing press;

FIG. 4 schematically shows a web exiting the printing section;

FIG. 5 schematically shows a print unit of the printing press;

FIG. 6 shows a graph illustrating a velocity and a displacement of the web during each 360 degree revolution of blanket cylinders of the printing press accordingly to an embodiment of the present invention; and

FIGS. 7 to 16 schematically show sequential views of the print unit shown in FIG. 5 printing on the web.

### DETAILED DESCRIPTION

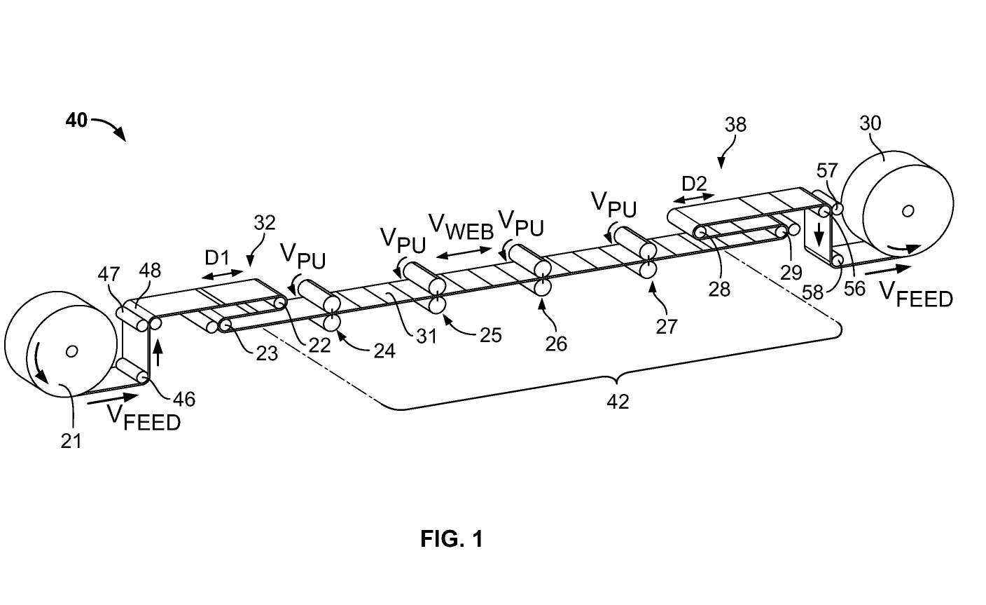

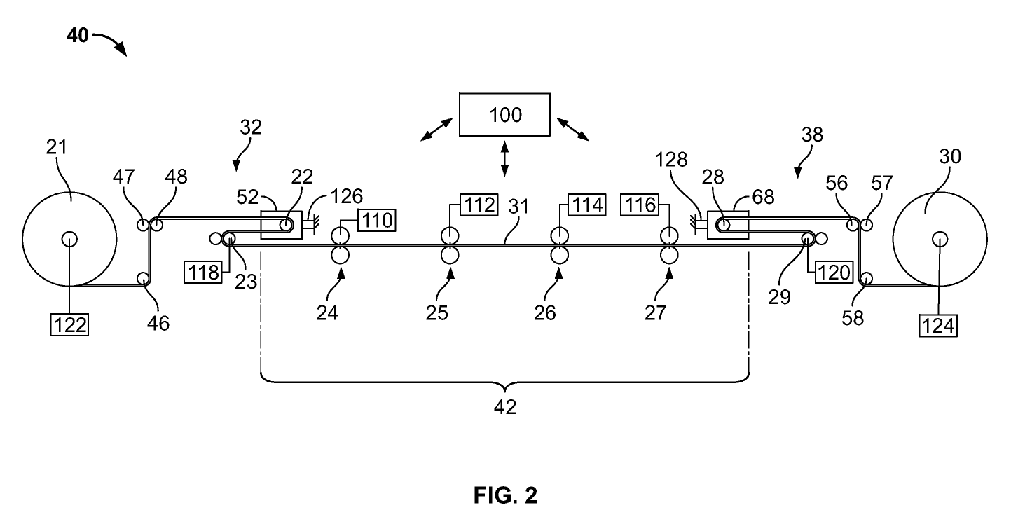

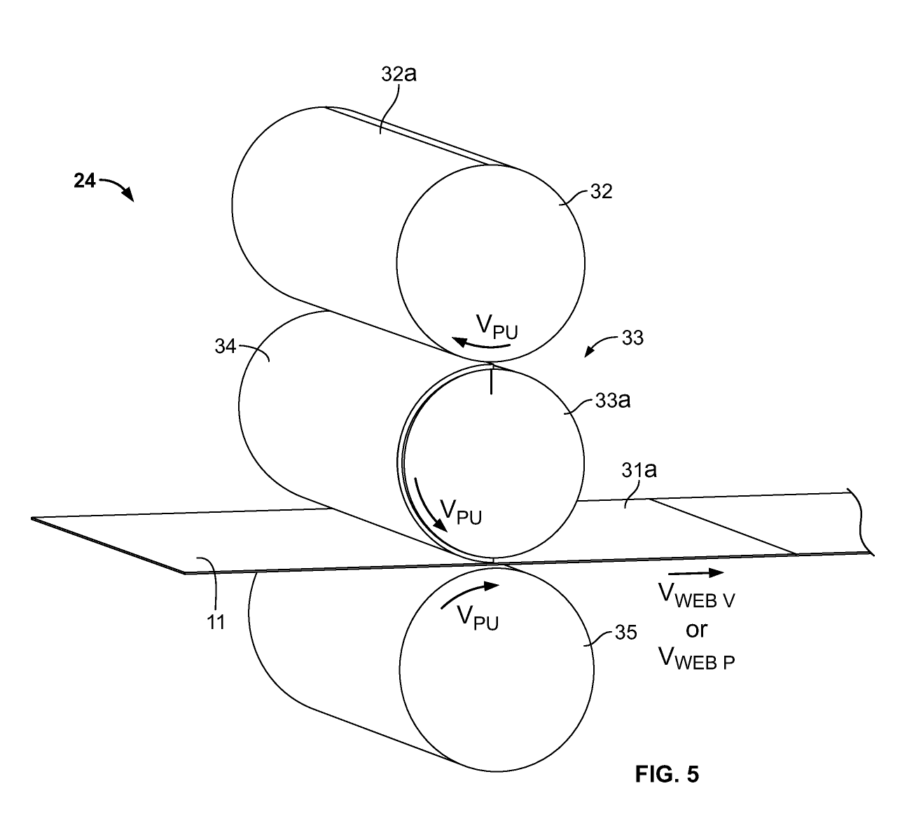

FIGS. 1 and 2 show a variable cutoff oscillating web printing press 40 according to an embodiment of the present invention. A web 31 is unwound from a roll by an unwind unit 21 so that web 31 travels at a constant feeding velocity V_{feed} when exiting unwind unit 21. Web 31 is then directed by rolls 46, 47, 48 downstream of unwind unit 21 into a compensator unit 32 downstream of rolls 46, 47, 48. Web passes around a compensator 22 of compensator unit 32, which is oscillated radially in accordance with the direction of arrows D1 during operation of press 40, for example via an actuating carriage 52 (FIG. 2) that is slid along horizontal rails by actuator 126, to vary the path of web 31. In a preferred embodiment, compensator 22 is an air bar, but in one alternative embodiment, compensator 22 may be roller. After passing compensator 22, web 31 contacts a web driver 23 downstream of compensator 22 that can be rotatably driven in both directions (i.e., clockwise and counterclockwise) during operation of press 40, in synchronization with the oscillation of compensator 22, to adjust the positioning of web 31. Web 31 then enters a printing section 42 downstream of web driver 23 and print units 24, 25, 26, 27 print images on web 31. Print units 24, 25, 26, 27 are merely exemplary and printing press 40 may include any number of print units in theory, from one to n. In this embodiment, each print unit 24, 25, 26, 27 may print a different colored image on web 31 so that printing press 40 prints four colored images on web 31. In FIGS. 1 and 2, print units 24, 25, 26, 27 are shown schematically and plate cylinders 32 (FIG. 5) are omitted for clarity.

In this embodiment, cylinders 32, 33, 35 (FIG. 5) of print units 24, 25, 26, 27 are each rotated at a constant velocity during operation, so that the cylinders 32, 33, 35 (FIG. 5) of each print unit 24, 25, 26, 27 each have a constant surface velocity Vₚᵤ. After printing, web 31 contacts a web driver 29 downstream of print section 42, which like web driver 23, can be rotatably driven in both directions (i.e., clockwise and counterclockwise) during operation of press 40. Web 31 then enters a compensator unit 38 downstream of web driver 29 and passes around a compensator 28 configured similar to compensator 22, which like compensator 22, is oscillated radially in accordance with the direction of arrows D2 towards and away from print section 42 during the operation of press 40, for example via an actuating carriage 68 (FIG. 2) that is slid along horizontal rails by an actuator 128, to vary the path of web 31. Web 31 is then directed by rolls 56, 57, 58 to a rewind unit 30, where web 31 is collected in a roll at the feeding velocity V_{feed}.

Printing units 24, 25, 26, 27 may be driven by at least one motor 110, 112, 114, 116, respectively, web drivers 23, 29 may be driven by motors 118, 120, respectively, and unwind and rewind units 30 may be driven by motors 122, 124, respectively. In order to synchronize operation between components of printing press 40, a controller 100 is provided that is in wireless or wired communication with motors 110, 112, 114, 116, 118, 120, 122, 124 and actuators 126, 128. By varying the velocities of motors 118, 120 and actuators 126, 128, controller 100 can vary the velocity of web 31 to match web 31 to the velocity of print units 24, 25, 26, 27 during printing and to vary the velocity of web 31, and change the direction that web 31 is moving, to properly align web 31 for printing.

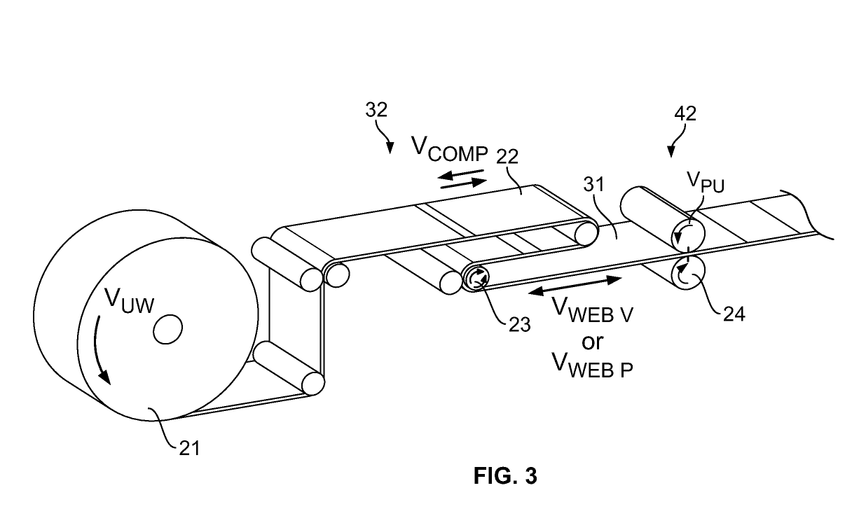

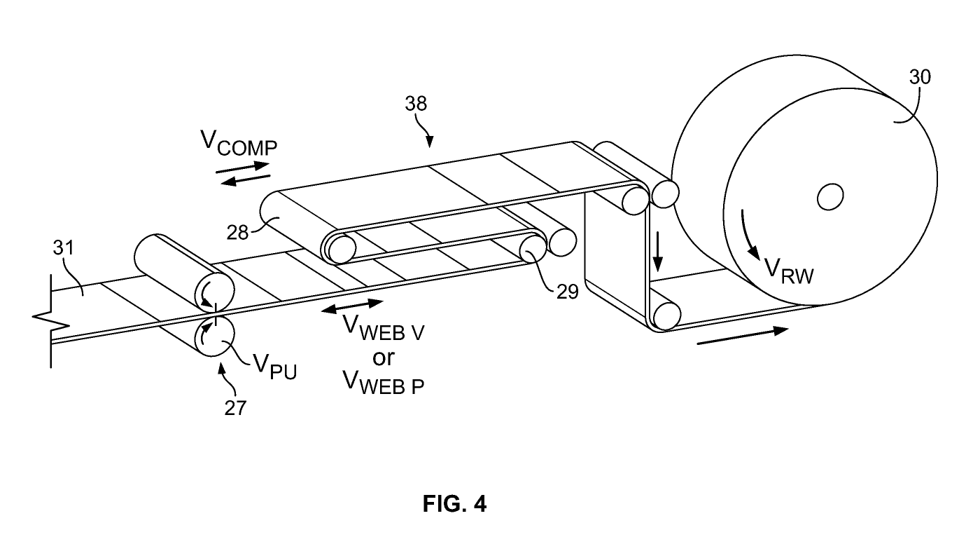

FIG. 3 shows web 31 entering printing section 42 and FIG. 4 shows web 31 exiting printing section 42. During operation of printing press 40, compensators 22, 28 and web drivers 23, 29 all act on web 31 in unison to oscillate web 31 with respect to print units 24, 25, 26, 27 and to handle the constant flow of web 31 from unwind unit 21 and to rewind unit 30. In this manner, web drivers 23, 29 assist compensators 22, 28 in varying the direction of the web in the printing section. Web drivers 23, 29 are driven in the same direction and at the same velocity as each other during operation and compensators 22, 28 oscillate in the same direction and at the same velocity as each other during operation. Unwind unit 21 operates at a velocity V_{uw} to unwind web 31, which then passes around compensator 22. Compensators 22, 28 are oscillated in unison towards and away from unwind unit 21 at a velocity V_{comp} to control the flow of web in printing section 42 and maintain continuity in the flow of web 31 as the direction of rotation of web driver 23 is varied. Web drivers 23, 29 work with compensators 22, 28 to vary the direction and a variable velocity V_{webv} of web 31 in printing section 42 when print units 24, 25, 26, 27 are not printing on web 31 and drive web 31 at a constant printing velocity V_{webp} when print units 24, 25, 26, 27 are printing on web 31. Rewind unit 30 operates at a constant velocity V_{rw} to rewind web 31.

Whenever the velocity of web 31 in printing section 42 is less than the feeding velocity V_{feed}, compensator 22 is slid away from unwind unit 21 (i.e., towards printing section 42) and compensator unit 32 acts to store web 31 that is being continuously fed from unwind unit 21. Whenever the velocity of web 31 in printing section 42 is greater than the feeding velocity V_{feed}, compensator 22 is slid towards unwind unit 21 (i.e., away from printing section 42) and web 31 is depleted from compensator unit 32. As print units 24, 25, 26, 27 print on web 31, the portion of web 31 in compensator unit 32 continues to be depleted.

Compensator unit 38 works in a similar way as compensator unit 32; however, when compensator unit 32 is storing web 31, compensator unit 38 is depleting web 31, and vice versa. Web drivers 23, 29 are synchronized and work in unison. During the printing of web 31 by print units 24, 25, 26, 27, web drivers 23, 29 drive web 31 forward such that the velocity V_{webp} of web 31 in printing section 42 is constant and equals the surface velocity Vₚᵤ of cylinders 32, 33, 35 (FIG. 5) of print units 24, 25, 26, 27. When the printing of a web section is finished, compensators 22, 28 are moved forward towards rewind unit 30 and web drivers 23, 29 are decelerated to decelerate web 31. Next, as compensators 22, 28 are still being moved forward, drivers 23, 29 are stopped and then caused to rotate backward so web 31 travels backward. Next, web drivers 23, 29 stop rotating again, reverse rotation again back to the forward direction while compensators 22, 28 are moved backward, so web 32 is accelerated forward and the variable velocity V_{webv} of web 31 in printing section 42 matches the surface velocity Vₚᵤ of cylinders 32, 33, 35 (FIG. 5) of print units 24, 25, 26, 27 at the desired moment. At the same time, compensators 22, 28 and web drivers 23, 29 synchronize with the cylinders 32, 33, 35 (FIG. 5) of print units 24, 25, 26, 27 so images are printed in the proper sections of web 31. Web drivers 23, 29 may be servo driven roller groups, linear drive units, pneumatic, mechanic or hydraulic groups. In a preferred embodiment, compensator units 32, 38 utilize servomotors. In alternative embodiments, compensator units 32, 38 may utilize pneumatic, mechanic or hydraulic actuators, or any combination thereof.

The feeding velocity V_{feed} of web 31 in unwind unit 21 and rewind unit 30 is less than or equal to the surface velocity Vₚᵤ of cylinders 32, 33, 35 (FIG. 5) of print units 24, 25, 26, 27. Also, the ratio between the feeding velocity V_{feed} of web 31 as web 31 leaves unwind unit 21 (which equals the rewind velocity V_{rw} of web 31 as web 31 enter rewind unit 30) and the surface velocity Vₚᵤ of cylinders 32, 33, 35 (FIG. 5) of print units 24, 25, 26, 27 is a function of the desired cutoff length (i.e., print length).

In an alternative embodiment, printing press 40 may not include web drivers 23, 29, and compensator units 32, 38 can control the flow of web 31, along with print units 24, 25, 26, 27, in printing section 42. Without web drivers 23, 29 (nondriven rollers or bars may be positioned in place of web drivers 23, 29), the web 31 in printing section 42 may be accelerated and decelerated solely by the back and forth movements of compensators 22, 28. Moving compensators 22, 28 forward toward rewind unit 30 may cause web 31 to be transported backward and moving compensators 22, 28 backward toward unwind unit 21 may cause web to be transported forward. In a system without web drivers 23, 29, errors in registration may be equal to the compensator web path length error.

However, the use of web drivers 23, 29 (e.g., as in the embodiment shown in FIGS. 1 to 4) improves the accuracy of the registration between print units 24, 25, 26, 27 and web 31. In a system with web drivers 23, 29, the compensator web path length error may merely result as a small change in tension at web drivers 23, significantly reducing registration errors at print units 24, 25, 26, 27.

FIG. 5 shows one of the print units 24, 25, 26, 27 of printing press 40, for example print unit 24. Print unit 24 includes a plate cylinder 32, a blanket cylinder 33 and an impression cylinder 35. Plate cylinder 32, blanket cylinder 33 and impression cylinder 35 are driven to have the same circumferential velocity (i.e., surface velocity) Vₚᵤ. Plate cylinder 32 may include an image carrying printing plate 32a and may receive ink from an ink train group and dampening solution from a dampening train group. Printing plate 32a may wrap around a portion of plate cylinder 32 or may wrap around the entire circumference of plate cylinder 32. Plate cylinder 32 may transfer an inked image to a printing surface of a blanket 34 on a cylinder body 33a of blanket cylinder 33, which transfers the image to web 31. In this embodiment, blanket 34 covers half of the circumference of blanket cylinder 33. A length of blanket 34 can be changed to vary the cutoff (i.e., print length) of images printed on web 31 by print unit 24 within minimum and maximum values.

In an alternative embodiment, print units 24, 25, 26, 27 may be perfecting units (i.e., arranged to print on both side of web 31) with impression cylinders 35 being replaced by another plate and blanket cylinder and ink and dampening train groups.

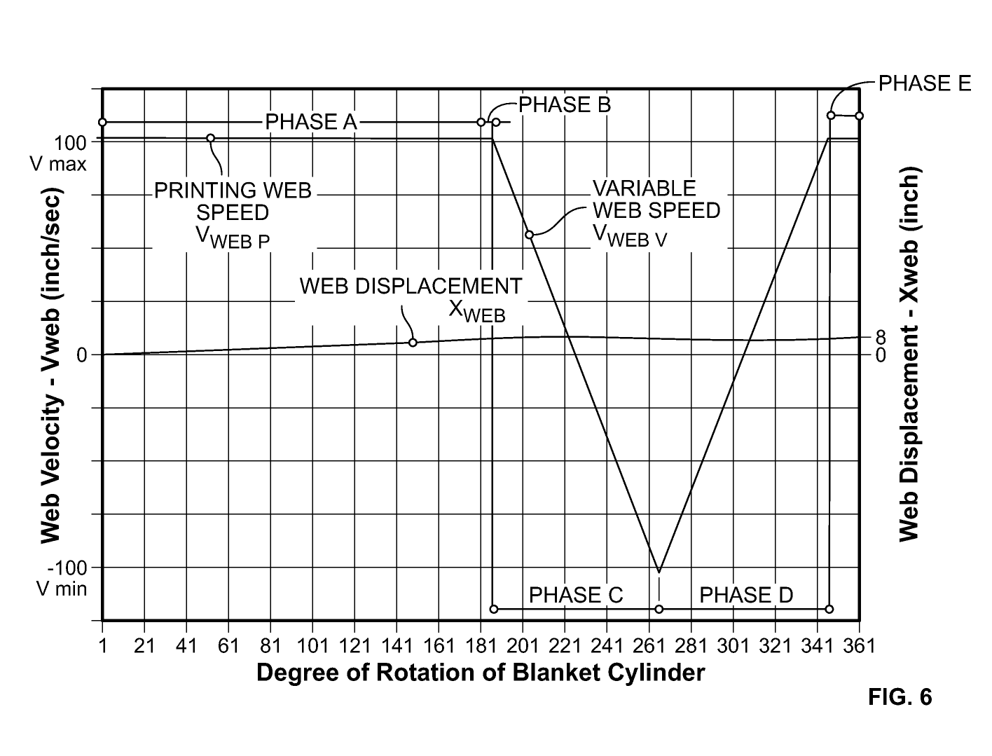

FIG. 6 shows a graph illustrating the velocity (V_{webv} and V_{webp}) and displacement X_{web} of web 31 during each 360 degree revolution of the cylinders 32, 33, 35 of print units 24, 25, 26, 27 accordingly to an embodiment of the present invention. The reference numbers used to describe FIG. 6 are the same as those used to describe FIGS. 1 to 5. During a phase A, web 31 may be moved forward towards rewind unit 30 at a constant maximum velocity Vₘₐₓ as printing units 24, 25, 26, 27 print on web 31, such that web displacement X_{web} uniformly increases. As a result, the printing velocity V_{webp} of web 31 as web 31 is printed in printing section 42 equals the maximum velocity Vₘₐₓ. Because blanket 34 covers half of the outer circumference of blanket cylinder 33, phase A coincides with half of one revolution of the cylinders of print units 24, 25, 26, 27. After phase A, when each print unit 24, 25, 26, 27 finishes printing a respective image on a respective web section of web 31, print units 24, 25, 26, 27 come out of contact with web 31 in a phase B and web 31 continues to travel at the maximum velocity Vₘₐₓ, such that web displacement X_{web} continues to uniformly increase. In a phase C, web 31 is decelerated to zero velocity and then is accelerated in the opposite direction (i.e., backward) until web 31 is traveling away from rewind unit 30 so that web 31 has a negative velocity with respect to the forward direction and travels at a minimum velocity Vₘᵢₙ (i.e., maximum negative velocity). Accordingly, at the beginning of phase C, web displacement X_{web} increases more gradually and halfway through phase C, web displacement X_{web} begins to decrease because web 31 has a negative velocity. Then, in a phase D, web 31 is accelerated to zero velocity, then accelerated again in the original direction (i.e., forward) until web 31 reaches the maximum velocity Vₘₐₓ. In the first half of phase D, web displacement X_{web} continues to decrease, but in the second half of phase D, web displacement X_{web} begins to increase again. In a phase E, web 31 continues to be transported at the maximum velocity Vₘₐₓ so that web 31 travels at the printing velocity V_{webp}, matching the velocity Vₚᵤ of the printing surfaces of print units 24, 25, 26, 27. In phase E, web displacement X_{web} uniformly increases. In phases B through E web 31 is not in contact with the printing units 24, 25, 26, 27 because the absence of the printing blankets 34 in half of blanket cylinders 33 forms a gap between web 31 and blanket cylinders 33 and impression cylinders 35. Then, phase A is repeated and print units 24, 25, 26, 27 print another respective image on another respective web section of web 31 adjacent to the respective image each print unit 24, 25, 26, 27 last printed on web 31.

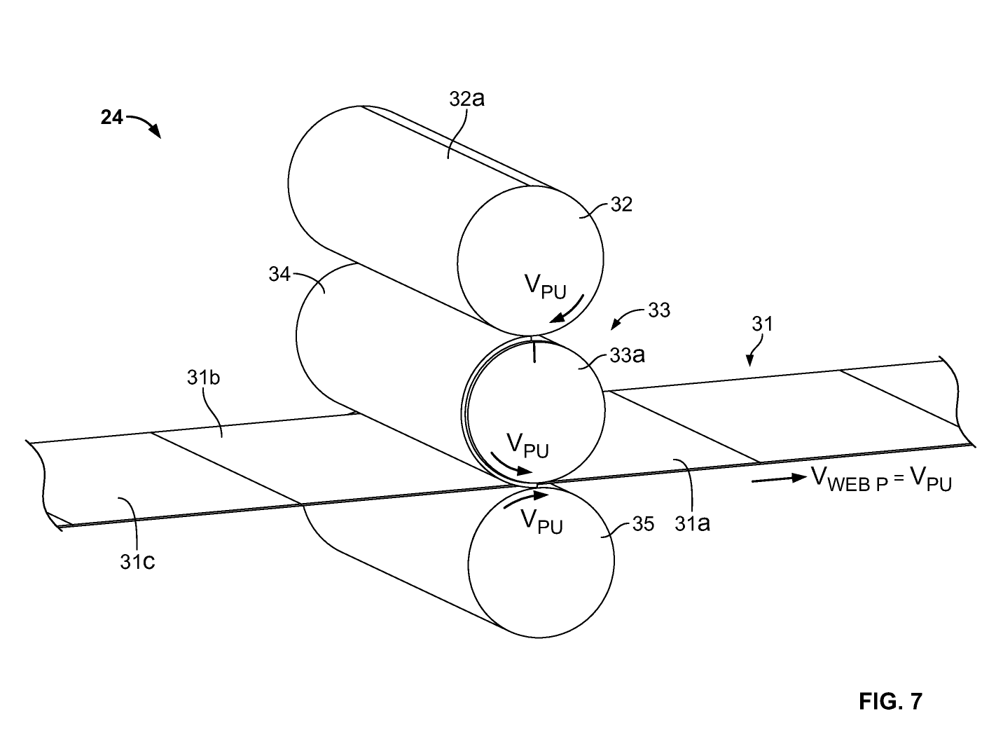

FIGS. 7 to 16 schematically show sequential views of print unit 24 printing on web 31. Print units 25, 26, 27 (FIG. 1) are configured in the same manner as print unit 24 and print in the same manner and at the same time as print unit 24. FIG. 7 shows blanket cylinder 33 of print unit 24 beginning to transfer an image from blanket 34 onto web 31 at a web section 31b (e.g., Phase A of FIG. 6). As blanket cylinder 33 prints the image on web section 31b, web 31 is moved so that the velocity V_{webp} of web 31 in printing section 42 equals the constant surface velocity Vₚᵤ of blanket 34 (e.g., V_{webp}=Vₘₐₓ (FIG. 6)). Also, as blanket cylinder 33 prints the image on web section 31b, each print unit 25, 26, 27 prints an image on a respective different web section of web 31 already printed by print unit 24.

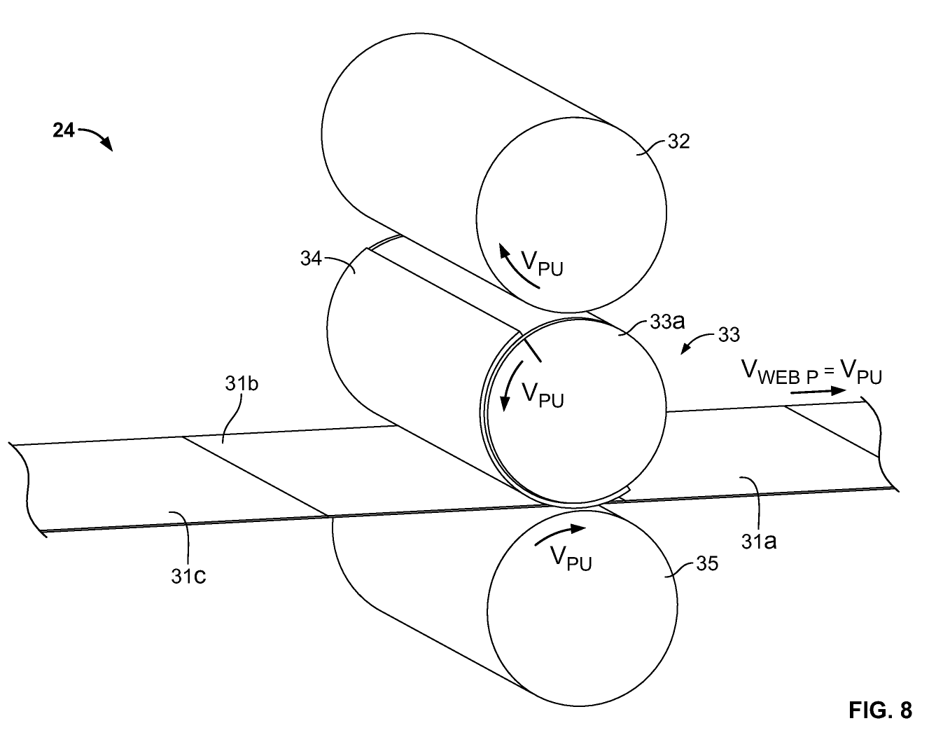

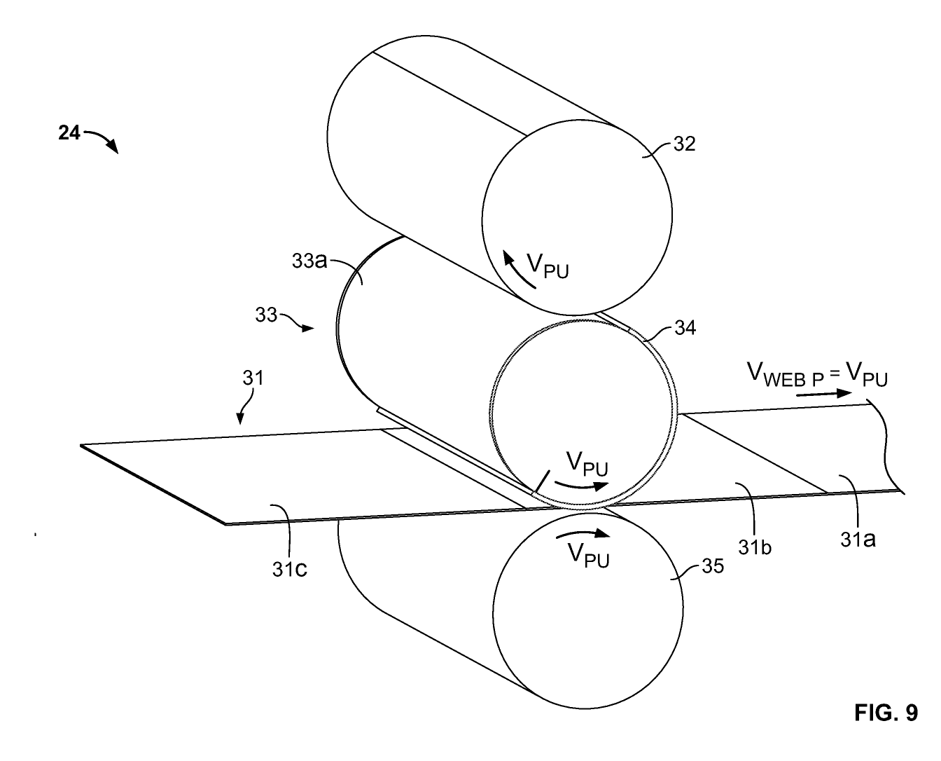

FIGS. 8 and 9 show blanket cylinder 33 of print unit 24 continuing to print the image in web section 31b (e.g., still in Phase A of FIG. 6). Web 31 is still traveling through print unit 24 at the maximum velocity Vₘₐₓ (FIG. 6), so that the printing velocity V_{webp} of web 31 equals the surface velocity Vₚᵤ of blanket 34. Plate cylinder 32 and impression cylinder 35 also rotate at surface velocity Vₚᵤ. Web section 31a, which was already printed on by blanket 34 and is downstream of print unit 24, travels towards print unit 25 (FIGS. 1 and 2).

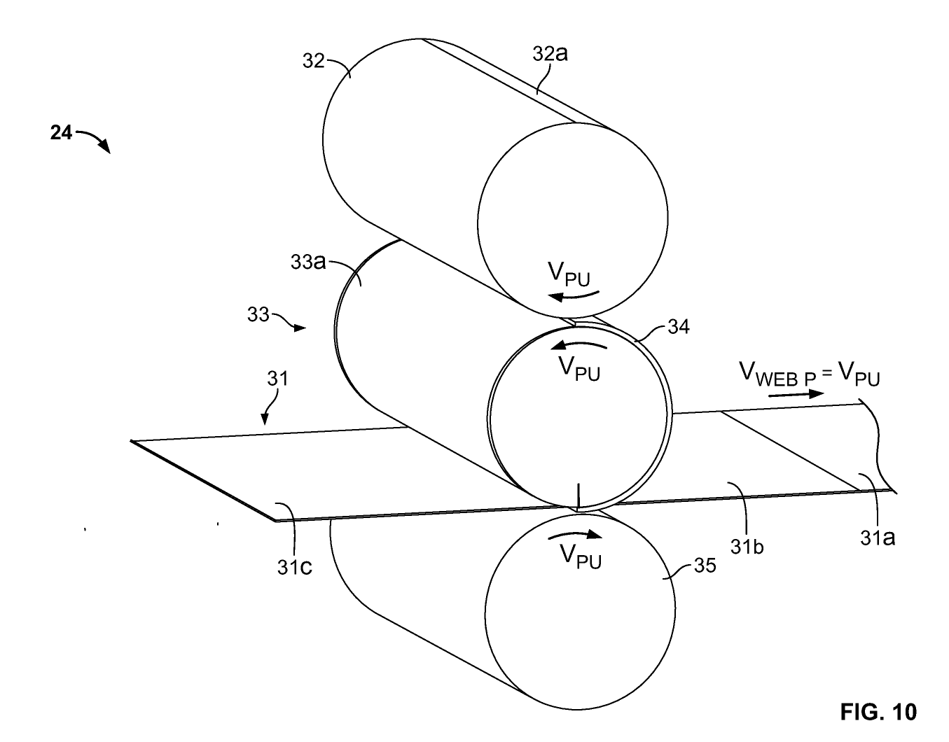

FIG. 10 shows print unit 24 just after blanket 34 completed printing the image in web section 31b (e.g., Phase B of FIG. 6) and blanket 34 is out of contact with web 31. Web 31 still travels at the maximum velocity Vₘₐₓ (FIG. 6) and plate cylinder 32 is beginning to transfer another inked image to blanket 34 for printing in a web section 31c upstream of web section 31b.

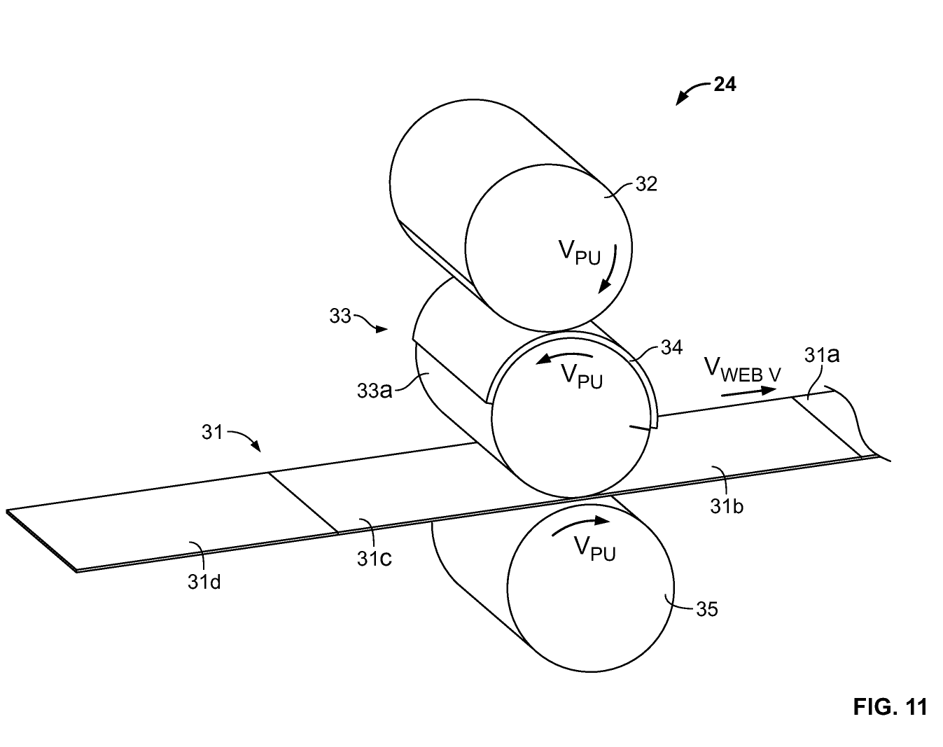

FIG. 11 shows web 31 traveling through print unit 24 without contacting blanket 34. Because web 31 no longer contacts blanket 34, web 31 can be transported at the variable velocity V_{webp} that differs from the surface velocity Vₚᵤ of blanket 34. At the instant shown in FIG. 11, the velocity V_{webv} of web 31 is less than the printing velocity V_{webp} and is being decreased (e.g., first half of Phase C in FIG. 6). Because the velocity V_{webv} of web 31 is less than feeding velocity V_{feed} of web 31, compensators 22, 28 (FIGS. 1 to 4) are being slid towards rewind unit 30. Driver rolls 23, 29 (FIGS. 1 to 4) are being decelerated.

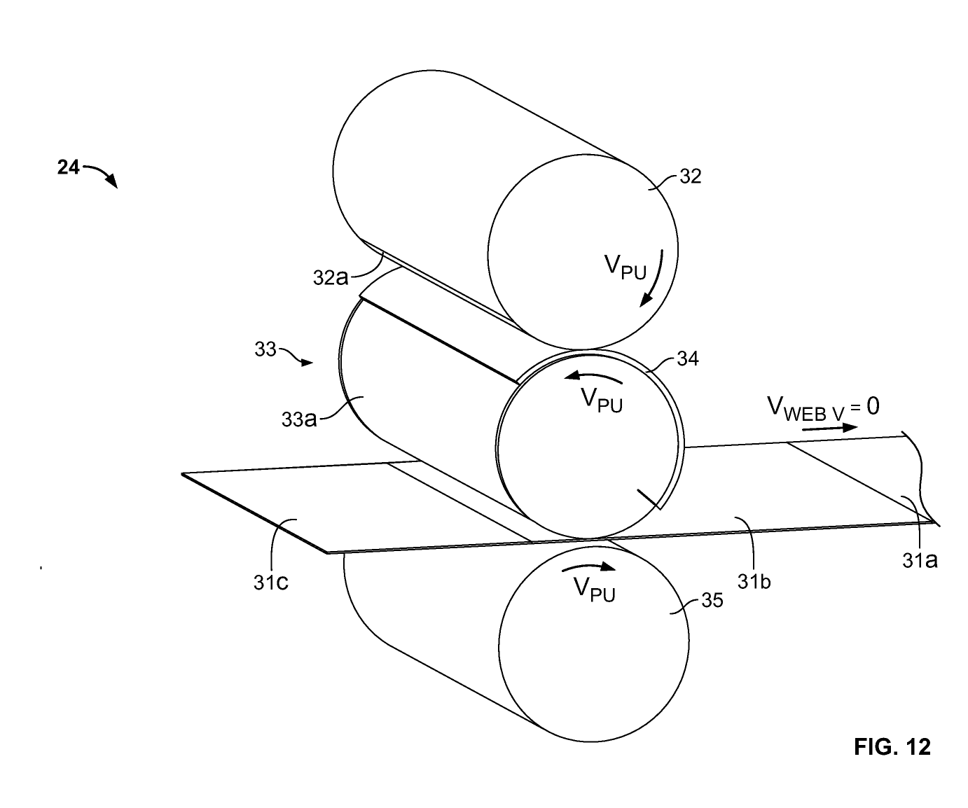

FIG. 12 shows web 31 at an instant where web 31 is stopped and the velocity V_{webv} of web 31 equals zero (e.g., middle of Phase C in FIG. 6). Driver rolls 23, 29 (FIGS. 1 to 4) also have a zero velocity and, with compensators 22, 28 (FIGS. 1 to 4), are about to begin to accelerating web 31 in the opposite direction that web 31 was traveling in FIGS. 7 to 11 (i.e., backward).

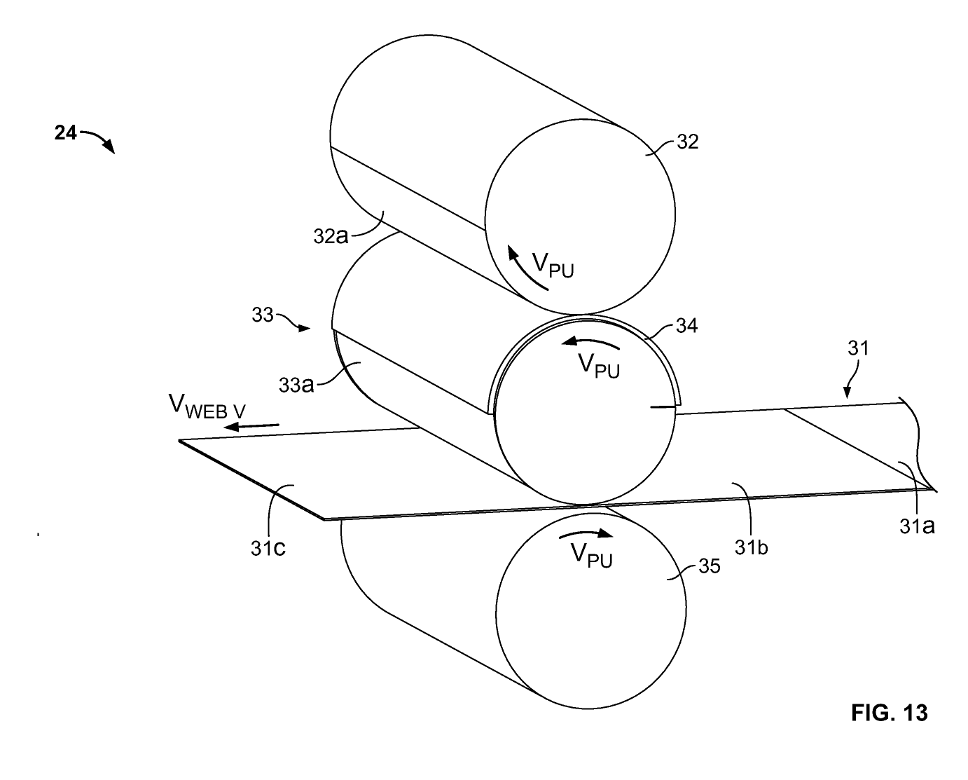

FIG. 13 shows web 31 traveling away from rewind unit 30 (FIG. 1) (e.g., second half of Phase C in FIG. 6). Compensators 22, 28 are being moved towards rewind unit 30 and driver rolls 23, 29 are being accelerated backward (e.g., counterclockwise) so that web 31 may be properly aligned with blanket 34 when blanket 34 returns to the printing position and so blanket 34 is aligned to print an image in web section 31c.

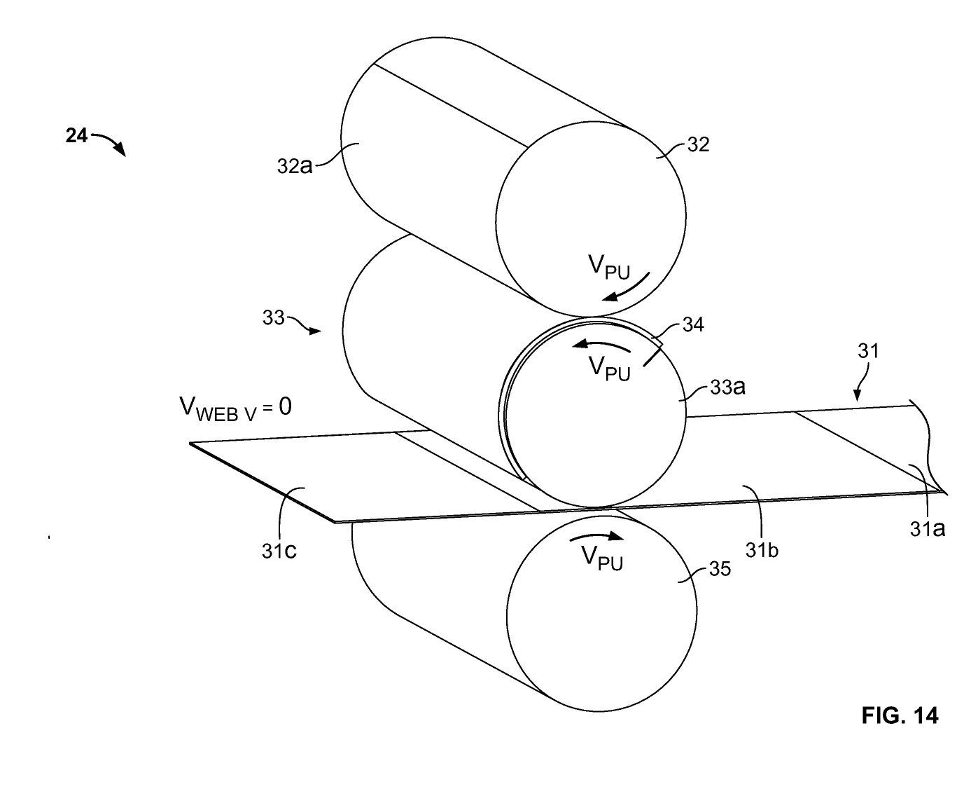

FIG. 14 shows web 31 at an instant after web 31 is decelerated back to a zero velocity and the velocity V_{webv} of web 31 in printing section 42 equals zero (e.g., middle of Phase D in FIG. 6). A leading edge of blanket 34 is approaching a printing nip of print unit 24.

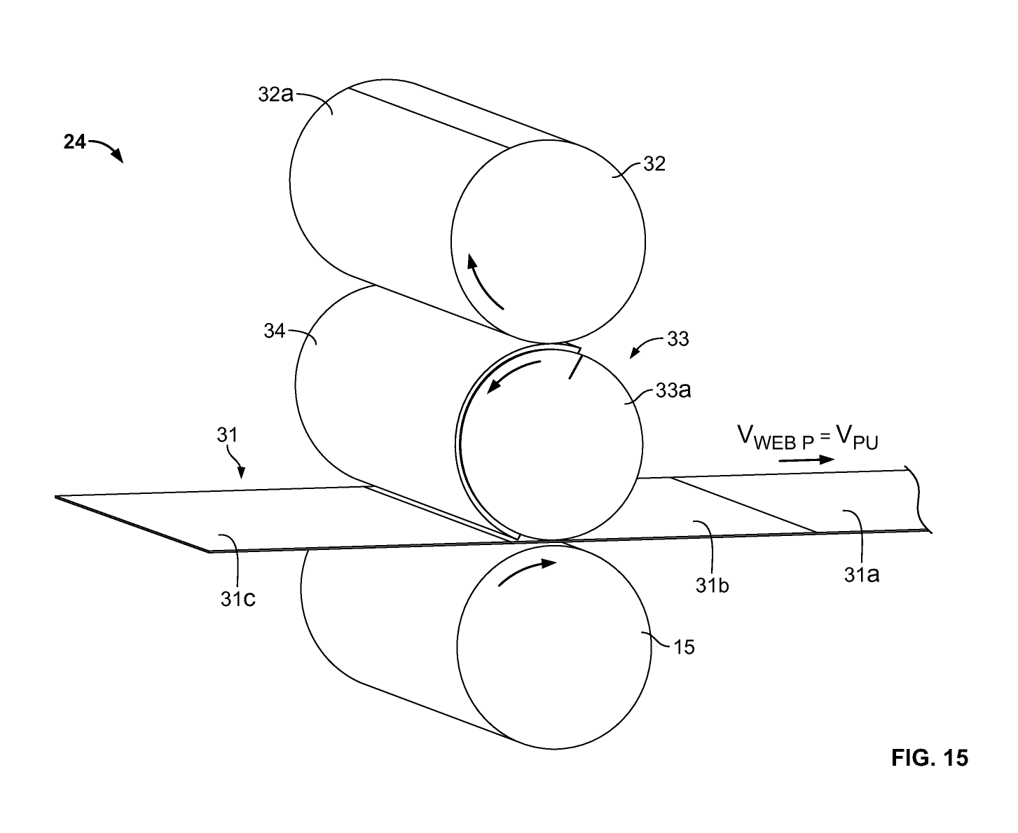

FIG. 15 shows web 31 traveling back toward rewind unit 30 (FIGS. 1, 2 and 4), with web 31 being accelerated by compensators 22, 28 and web drivers 23, 29 back to the printing velocity V_{webp} (e.g., second half of Phase D in FIG. 6). The phasing and velocity of compensators 22, 28 and web drivers 23, 29 are being set so that the velocity V_{webp} of web 31 in printing section 42 equals the surface velocity Vₚᵤ of cylinders 32, 33, 35 of print unit 24 when a leading edge of blanket 34 contacts web 31 and so that the leading edge of blanket 34 contacts a leading edge of web section 31c.

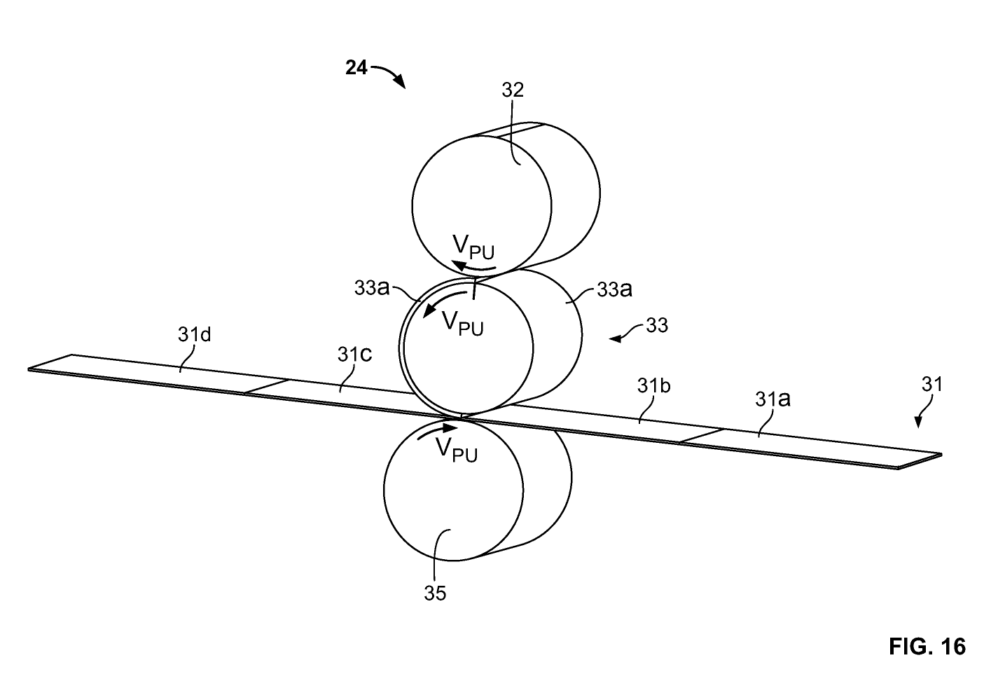

FIG. 16 shows web 31 traveling with web velocity V_{webp} in printing section 42 equal to the surface velocity Vₚᵤ of blanket 34 and impression cylinder 35 (e.g., Phase A in FIG. 6). Blanket 34 is printing the image in web section 31c so the image is properly aligned in web section 31c. Print unit 24 is operated in the same manner as shown in FIGS. 7 to 15 to print the image in web section 31c and synchronize web 31 with blanket cylinder 33 so blanket 34 prints another image in a web section 31d upstream of web section 31c. Print units 25, 26, 27 operate to print images in the same manner in web sections 31a, 31b, 31c, 31d so that each web section 31a, 31b, 31c, 31d is printed with a four color image.

In order to vary the cutoff of images printed by printing press 40 when changing from one print job to the next, printing plates 32a are replaced with new printing plates carrying longer or shorter images and blankets 34 may be replaced with new blankets that have a circumferential length that correspond to the images on the new printing plates. Blankets 34 may be strips that are removably affixed to the surfaces of cylinder bodies 33a. Cylinder bodies 33a may include a mandrel onto which a removable sleeve may be slid. The removable sleeves may include blankets that are fixedly attached to the sleeves or can be configured so that blankets can be removably attached to the sleeves. For example when a small or medium sized print job (e.g., minimal or moderate amount of printed products) needs to be run on press 40, the blankets 34, in the form of strips, can be removed from the removable sleeve and replaced with blankets required for the smaller print job. The oscillating capability of the press 40 (due to compensators 22, 28 and optionally drivers 23, 29) allows the small or medium sized print job to be run on press 40 without varying the diameters of blanket cylinders 33. Also, for example for larger or reoccurring print jobs, the removable sleeves may be removed and replaced with sleeves having different sized blankets and having a larger or smaller diameter and press 40 can be run at a constant velocity (i.e., compensators 22, 28 are not oscillated and drivers 23, 29 are run at a constant velocity; blankets cover substantially the entire circumference of the sleeves) or a variable velocity (i.e., compensators 22, 28 are oscillated and drivers 23, 29 are run at a variable velocity; blankets cover only a portion of the circumference of the sleeves). Thus, press 40 may have flexibility and may allow different options for varying cutoff.

Additionally, press 40 may advantageously slow down production speeds and eliminate errors caused by higher production speeds when a faster production is not required for a particular print job. However, press 40 may still run at a high production speed when necessary by restricting or eliminating the oscillation of compensators 22, 28 and the varying of the velocity of drivers 23, 29.

In a preferred embodiment, the length of blankets 34 corresponds to length of images printed by press 40. In this case, a change in image length (i.e., new printing plates have images of different lengths than the previous print job) causes blankets 34 to have to be replaced with blankets corresponding to the image length. In an alternative embodiment, blankets 34 may be longer than the images blankets 34 print on web 31, so that blankets 34 may only need to be replaced for images than are longer than blankets 34. If the images are within the length of blankets 34, it is possible that only plates 32a need to changed and the phasing of compensators 22, 28 and drivers 23, 29 are adjusted in a cutoff change. In preferred embodiments, blankets 34 cover half or less than half of the circumference of the respective blanket cylinder 33.

In the preceding specification, the invention has been described with reference to specific exemplary embodiments and examples thereof. It will, however, be evident that various modifications and changes may be made thereto without departing from the broader spirit and scope of invention as set forth in the claims that follow. The specification and drawings are accordingly to be regarded in an illustrative manner rather than a restrictive sense.

1. A printing press comprising:
a printing section including at least one printing unit printing images on a web; and
at least one compensator unit for varying a direction of travel of the web in the printing section during operation of the at least one printing unit.

2. The printing press recited in claim 1 further comprising at least one web driver for assisting the at least one compensator unit in varying the direction of the web in the printing section.

3. The printed press recited in claim 1 wherein the at least one compensator unit includes at least one compensator that is oscillated radially to vary the direction of travel of the web in the printing section.

4. The printing press recited in claim 1 wherein the at least one compensator unit includes a first compensator unit upstream of the printing section and a second compensator unit downstream of the printing section.

5. The printing press recited in claim 4 wherein the at least one compensator unit includes at least one actuator for oscillating the first compensator unit and the second compensator unit in unison.

6. The printing press recited in claim 4 further comprising an unwind unit upstream of the first compensator unit feeding the web towards the first compensator unit at a feeding velocity.

7. The printing press recited in claim 6 further comprising a rewind unit downstream of the second compensator unit collecting the web from the second compensator unit at a collecting velocity.

8. The printing press recited in claim 1 wherein the at least one printing unit includes at least one blanket cylinder that comes in and out of contact with the web during each revolution of the at least one blanket cylinder.

9. The printing press recited in claim 8 wherein the at least one compensator unit varies the direction of travel of the web in the printing section during each revolution of the at least one blanket cylinder when the at least one blanket cylinder is out of contact with the web.

10. A method of printing on a web comprising the steps of:
printing a first image of a first print job on a web traveling in a first direction;
transporting the web in a second direction opposite the first direction;
transporting the web in the first direction; and
printing a second image of the first print job on the web adjacent to the first image.

11. The method recited in claim 10 wherein the first and second images are printed on the web using a first printing blanket and the method further comprises the steps of:
replacing the first printing blanket with a second printing blanket of a different length than the first printing blanket; and
printing a first image of a second print job on the web with the second printing blanket.

12. The method recited in claim 10 wherein the first image of the first print job is printed on the web by a cylinder and during the step of transporting the web in a second direction opposite the first direction the cylinder is out of contact with the web.

13. The method recited in claim 10 wherein the step of transporting the web in a second direction opposite the first direction includes sliding a compensator away from a printing unit printing the first image of the first print job on the web.

14. The method recited in claim 13 wherein the step of transporting the web in a second direction opposite the first direction includes reversing a direction of rotation of a roller pair transporting the web.

15. A printing press comprising:
a printing section including a plurality of printing units, each printing unit including a plate cylinder, a blanket cylinder and a third cylinder arranged for a web to pass between the blanket cylinder and the third cylinder;
a first compensator unit upstream of the printing section; and
a second compensator unit downstream of the printing section, the first and section compensator units varying a direction of travel of the web in the printing section during operation of the plurality of printing units.

16. The printing press recited in claim 15 further comprising a first web driver for assisting the first compensator unit in varying the direction of the web in the printing section, the first web driver positioned downstream of the first compensator unit and upstream of the printing section.

17. The printing press recited in claim 16 further comprising a second web driver for assisting the second compensator unit in varying the direction of the web in the printing section, the second web driver positioned downstream of the printing section and upstream of the second compensator unit.

18. The printing press recited in claim 17 further comprising at least one actuator for oscillating the first and second compensator units, a first motor for driving the first web driver, a second motor for driving the second web driver and a controller controlling the at least one actuator, the first motor and the second motor such that the first compensator unit, the second compensator unit, the first web driver and the second web driver move the web forward and backward in unison.

19. The printing press recited in claim 15 further comprising an unwind unit upstream of the first compensator unit feeding the web at a velocity that is less than a surface velocity of the plate cylinders, the blanket cylinders and the third cylinders of the printing units.

20. The printing press recited in claim 15 further comprising a rewind unit downstream of the second compensator unit rewinding the web at a velocity that is less than a surface velocity of the plate cylinders, the blanket cylinders and the third cylinders of the printing units.
